(19) United States
(12) Patent Application Publication
(10) Pub. No.: US 2011/0096009 A1
(43) Pub. Date: Apr. 28, 2011

(54) DISPLAY DEVICE AND SEMICONDUCTOR DEVICE

(75) Inventors: Yoshiyuki KUROKAWA, Sagamihara (JP); Takayuki IKEDA, Atsugi (JP)

(73) Assignee: SEMICONDUCTOR ENERGY LABORATORY CO., LTD., Kanagawa-ken (JP)

(21) Appl. No.: 12/905,361

(22) Filed: Oct. 15, 2010

(30) Foreign Application Priority Data
Oct. 26, 2009 (JP) 2009-245530

(51) Int. Cl. G06F 3/041

(52) U.S. Cl. 345/173

(57) ABSTRACT

It is an objective to provide a display device capable of detecting a position and a motion of an object even when the object is not in contact with a display panel. The display device includes a display panel provided with photo sensors. When an object is approaching the display panel, the display device detects a shadow of the object, which is cast over the display panel in such a manner that ambient light is blocked by the object, using the photo sensors. A position or a motion of the shadow is detected, so that a position or a motion of the object is detected. The detection can be operated even when the object is not in contact with the display panel.

### TECHNICAL FIELD

The technical field relates to a display device and a semiconductor device and additionally relates to a driving method and a manufacturing method thereof.

### BACKGROUND ART

In recent years, a display panel provided with a touch sensor has attracted attention. The touch sensor is classified as a resistive touch sensor, a capacitive touch sensor, an optical touch sensor, and the like according to the operation principle. An object to be detected (e.g., a pen or a finger) touches a display device, whereby data can be input to the display device.

A display device equipped with an image capture function by being provided with a contact area sensor which captures an image is given as an example of a device in which the optical touch sensor is included (for example, see Patent Document 1).

In addition, a technique for personal authentication with a touch sensor provided in a device which does not necessarily have a display panel, such as a fingerprint authentication device, has been proposed.

### REFERENCE

[Patent Document 1] Japanese Published Patent Application No. 2001-292276

### DISCLOSURE OF INVENTION

In the display panel (also referred to as an input portion) provided with the above touch sensors, the surface of the display panel continues to be touched by an object. Therefore, the display panel is easily dirtied and has a possibility that the display quality is deteriorated. In addition, proper mechanical strength is required for the display panel. Furthermore, there is a problem in that the users of the display panel tend to be tired when the surface of the display panel is hard, for example. The device which is not provided with the display panel also has a problem; that is, a portion which is touched by an object (also referred to as an input portion) tends to be dirty, for example.

In view of the above problems, it is an objective to make it possible that a device detects a position and a motion of an object even when the object is not in contact with an input portion.

In addition, it is an objective to make it possible that a device detects an object both when the object is in contact with an input portion and when the object is not in contact with the input portion.

According to one embodiment of the present invention, a semiconductor device includes an input portion in which photo sensors are arranged and detects a shadow cast over the input portion when an object blocks ambient light while the object approaches the input portion using the photo sensors. A position or a motion of the object is detected using the shadow of the object. Note that the semiconductor device may be a device which is provided with a display panel (also referred to as a display device) or may be a device which is not provided with a display panel.

In addition, according to another embodiment of the present invention, a display device includes a display panel in which photo sensors are arranged and detects light which is emitted from the display panel and reflected from an object using the photo sensors when the object approaches the display panel. That is, a position or a motion of the object is detected using light reflected from the object.

With such structures, an object can be detected even when the object is not in contact with the input portion (the display panel).

In addition, according to another embodiment of the present invention, a display device which has a function of detecting a contactless object includes a display panel in which pixels including a photo sensor are arranged in matrix, and an image processing portion. The photo sensor includes a unit for detecting a shadow of the object cast over the display panel, and the image processing portion includes a unit for detecting a position of the object using a position of the shadow of the object and a unit for detecting a motion of the object using a motion of the shadow.

In addition, according to another embodiment of the present invention, a display device which has a function of detecting a contactless object includes a display panel in which pixels including a photo sensor are arranged in matrix, and an image processing portion. The photo sensor includes a unit for detecting a shadow of the object cast over the display panel, and the image processing portion includes a unit for detecting a position of the object using a position of the shadow of the object and a unit for detecting a motion of the object using a motion of the shadow. In the unit for detecting a position of the object, the display panel is divided into a plurality of areas, and positional data of an area which includes a largest amount of the pixels detecting the shadow of the object is identified as positional data of the object.

In addition, according to another embodiment of the present invention, a display device which has a function of detecting a contactless object includes a display panel in which pixels including a photo sensor are arranged in matrix, and an image processing portion. The photo sensor includes a unit for detecting a shadow of the object cast over the display panel, and the image processing portion includes a unit for detecting a position of the object using a position of the shadow of the object and a unit for detecting a motion of the object using a motion of the shadow. In the unit for detecting a position of the object, the display panel is divided into a plurality of areas, and positional data of an area which includes a largest amount of the pixels detecting the shadow of the object is identified as positional data of the object. In the unit for detecting a motion of the object, the positional data is continuously obtained, and the positional data continuously obtained are compared, so that a motion of the object is detected.

In addition, according to another embodiment of the present invention, a display device which has a function of detecting a contactless object includes a display panel including a photodetection portion in which pixels including a first photo sensor are arranged in matrix and an area sensor in which pixels including a second photo sensor are arranged in matrix, and an image processing portion. The first photo sensor includes a unit for detecting a shadow of the object cast over the display panel, and the image processing portion includes a unit for detecting a position of the object using a position of the shadow of the object and a unit for detecting a motion of the object using a motion of the shadow.

In addition, according to another embodiment of the present invention, a display device which has a function of detecting a contactless object includes a display panel including a photodetection portion in which pixels including a first photo sensor are arranged in matrix and an area sensor in which pixels including a second photo sensor are arranged in matrix, and an image processing portion. The first photo sensor includes a unit for detecting a shadow of the object cast over the display panel, and the image processing portion includes a unit for detecting a position of the object using a position of the shadow of the object and a unit for detecting a motion of the object using a motion of the shadow. In the unit for detecting a position of the object, the display panel is divided into a plurality of areas, and positional data of an area which includes a largest amount of the pixels detecting the shadow of the object is identified as positional data of the object.

In addition, according to another embodiment of the present invention, a display device which has a function of detecting a contactless object includes a display panel including a photodetection portion in which pixels including a first photo sensor are arranged in matrix and an area sensor in which pixels including a second photo sensor are arranged in matrix, and an image processing portion. The first photo sensor includes a unit for detecting a shadow of the object cast over the display panel, and the image processing portion includes a unit for detecting a position of the object using a position of the shadow of the object and a unit for detecting a motion of the object using a motion of the shadow. In the unit for detecting a position of the object, the display panel is divided into a plurality of areas, and positional data of an area which includes a largest amount of the pixels detecting the shadow of the object is identified as positional data of the object. In the unit for detecting a motion of the object, the positional data is continuously obtained, and the positional data continuously obtained are compared, so that a motion of the object is detected.

In addition, according to another embodiment of the present invention, a display device includes a display panel including a photodetection portion in which pixels including an infrared light sensor are arranged in matrix and an area sensor in which pixels including a visible light sensor are arranged in matrix. The photodetection portion includes a unit for detecting light which is emitted from the display panel and reflected from the object when the object is not in contact with the display panel. The area sensor includes a unit for detecting light which is emitted from the display panel and reflected from the object when the object is in contact with the display panel.

In addition, the number of the second photo sensors may be more than the number of the first photo sensors.

In addition, the second photo sensors may be arranged around the first photo sensors.

A contactless object can be detected, so that the object touches the input portion (the display panel) less frequently; therefore, the display quality can be prevented from deteriorating.

In addition, a function of detecting a contactless object and a function of detecting a touch object can be used as appropriate depending on the application.

### BRIEF DESCRIPTION OF DRAWINGS

FIG. 1 illustrates a structure of a display panel.

FIG. 2 illustrates a structure of a display panel.

FIG. 3 illustrates a structure of a display panel.

FIG. 4 is a timing chart.

FIG. 5 illustrates a structure of a display panel.

FIG. 6 is a cross-sectional view of a display panel.

FIG. 7 is a cross-sectional view of a display panel.

FIG. 8 illustrates a structure of a display panel.

FIGS. 9A to 9D each show an example of an electronic device.

FIG. 10 illustrates image processing.

FIGS. 11A and 11B illustrate image processing.

FIG. 12 is a cross-sectional view of a display panel.

FIG. 13 shows an example of an electronic device.

### BEST MODE FOR CARRYING OUT THE INVENTION

Embodiments are described below in detail with reference to the accompanying drawings. However, since embodiments described below can be implemented in many different modes, it is easily understood by those skilled in the art that various changes and modifications can be made without departing from the spirit and scope of the present invention. Therefore, the present invention should not be construed as being limited to the description in the following embodiments. Note that, in all the accompanying drawings for describing the embodiments, the same parts or parts having similar functions are denoted by the same reference numerals in different drawings, and repetitive descriptions are omitted.

### Embodiment 1

In this embodiment, an example of a display panel is described.

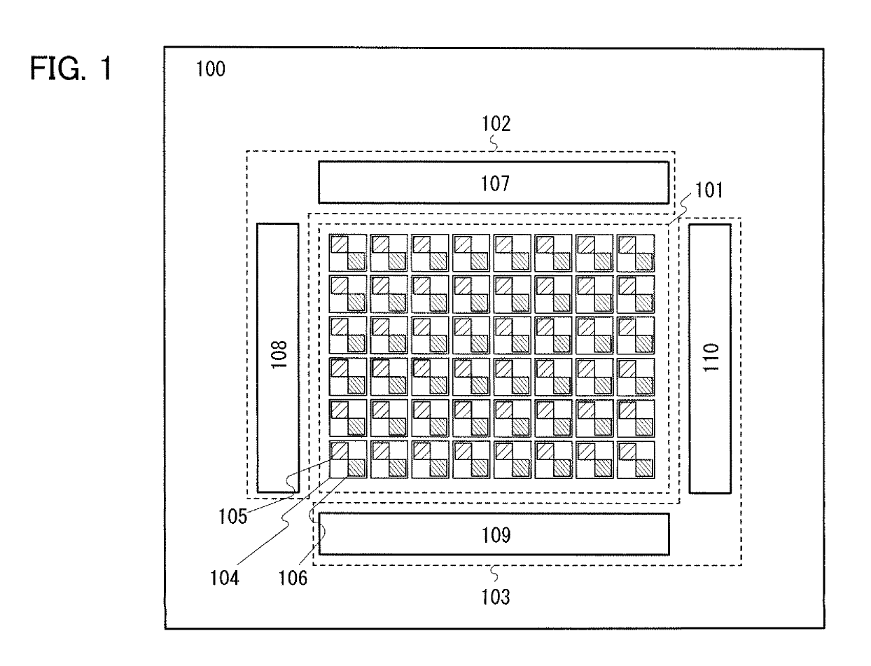

FIG. 1 is an example of a structure of a display panel. A display panel 100 includes a pixel circuit 101, a display element control circuit 102, and a photo sensor control circuit 103. The pixel circuit 101 includes a plurality of pixels 104 arranged in a matrix of rows and columns. Each of the pixels 104 includes a display element 105 and a photo sensor 106. Note that the photo sensor 106 may be provided outside the pixel 104. Moreover, the number of photo sensors 106 may be different from the number of display elements 105.

Each of the display elements 105 includes a thin film transistor (TFT), a storage capacitor, a liquid crystal element, and the like. The thin film transistor has a function of controlling injection or discharge of charge to/from the storage capacitor. The storage capacitor has a function of holding charge which corresponds to voltage to be applied to the liquid crystal element. The liquid crystal element is supplied with voltage and controls whether to transmit light or not; thus gray levels are displayed. Light that a light source (a backlight) emits from the rear side of a liquid crystal display device is used for the light passing through the liquid crystal element.

Note that the case where a liquid crystal element is included in each of the display elements 105 is described above; however, other elements such as a light emitting element may be included instead. The light emitting element is an element in which the luminance is controlled by current or voltage; specifically, a light emitting diode, an OLED (organic light emitting diode), and the like are given.

The photo sensor 106 includes an element which has a function of generating an electrical signal when receiving light (also referred to as a photo detector) and a thin film transistor. A photodiode and the like can be used as the photo detector. Note that light which the photo sensor 106 receives is light which is emitted from the inside (such as a backlight) of a display device and reflected by an object, light such as ambient light which is reflected by an object, light which is emitted from an object itself, or a portion where light such as ambient light is blocked by an object (a shadow).

The display element control circuit 102 controls the display elements 105 and includes a display element driver circuit 107 which inputs a signal to the display elements 105 through signal lines (also referred to as source signal lines) such as video data signal lines, and a display element driver circuit 108 which inputs a signal to the display elements 105 through scanning lines (also referred to as gate signal lines). For example, the display element driver circuit 108 to which the scanning lines are connected has a function of selecting display elements 105 included in pixels placed in a particular row. The display element driver circuit 107 to which the signal lines are connected has a function of applying a given potential to the display elements 105 which are selected by the display element driver circuit 108. Note that thin film transistors are in conduction state in the display elements to which a high potential is applied by the display element driver circuit 108 connected to the scanning lines, so that charge supplied from the display element driver circuit 107 connected to the signal lines is provided.

The photo sensor control circuit 103 controls the photo sensors 106 and includes a photo sensor readout circuit 109 to which signal lines such as photo sensor output signal lines and photo sensor reference signal lines are connected and a photo sensor driver circuit 110 to which the scanning lines are connected. The photo sensor driver circuit 110 connected to the scanning lines has a function of selecting photo sensors 106 included in pixels placed in a particular row and performing reset operation and selection operation, which are described below. The photo sensor readout circuit 109 connected to the signal lines has a function of extracting an output signal of the selected photo sensors 106. Note that the photo sensor readout circuit 109 connected to the signal lines can have a structure in which an output signal of the photo sensor which is an analog signal is extracted as an analog signal to the outside of the display panel by an operational amplifier, or a structure in which the output signal is converted into a digital signal by an A/D converter circuit and then extracted to the outside of the display panel.

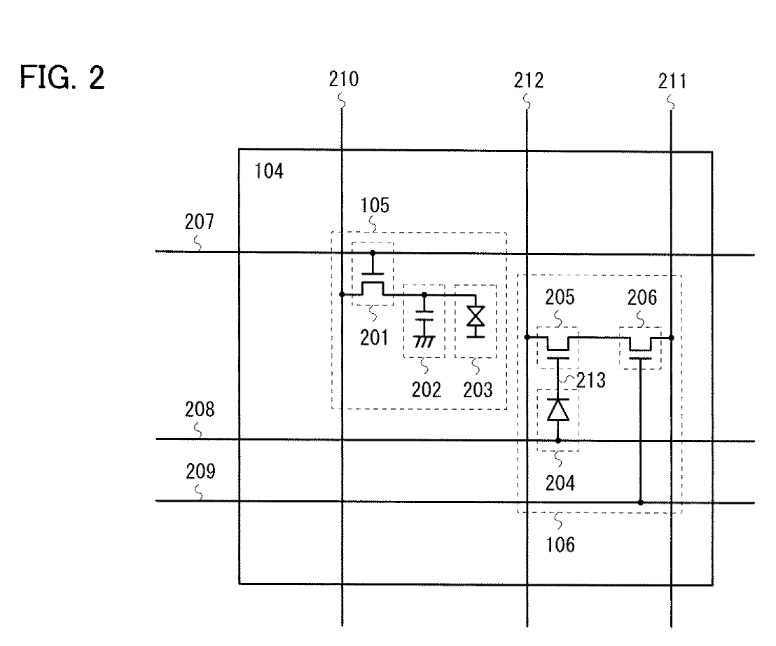

A circuit diagram of the pixel 104 is described with reference to FIG. 2. The pixel 104 includes the display element 105 including a transistor 201, a storage capacitor 202, and a liquid crystal element 203, and the photo sensor 106 including a photodiode 204, a transistor 205, and a transistor 206.

A gate of the transistor 201 is electrically connected to a gate signal line 207, one of a source and a drain of the transistor 201 is electrically connected to a video data signal line 210, and the other of the source and the drain of the transistor 201 is electrically connected to one electrode of the storage capacitor 202 and one electrode of the liquid crystal element 203. The other electrode of the storage capacitor 202 and the other electrode of the liquid crystal element 203 are each held at a particular potential. The liquid crystal element 203 includes a pair of electrodes and a liquid crystal layer provided between the pair of electrodes.

When a potential “H (high)” is applied to the gate signal line 207, the transistor 201 supplies the potential of the video data signal line 210 to the storage capacitor 202 and the liquid crystal element 203. The storage capacitor 202 holds the supplied potential. The liquid crystal element 203 changes light transmittance in accordance with the supplied potential.

One electrode of the photodiode 204 is electrically connected to a photodiode reset signal line 208, and the other electrode of the photodiode 204 is electrically connected to a gate of the transistor 205. One of a source and a drain of the transistor 205 is electrically connected to a photo sensor reference signal line 212, and the other of the source and the drain of the transistor 205 is electrically connected to one of a source and a drain of the transistor 206. A gate of the transistor 206 is electrically connected to a gate signal line 209, and the other of the source and the drain of the transistor 206 is electrically connected to a photo sensor output signal line 211.

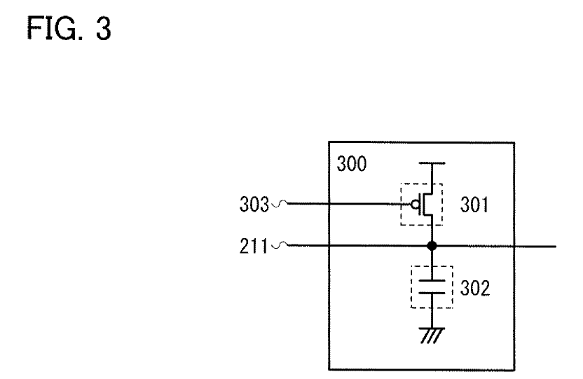

Next, a structure of the photo sensor readout circuit 109 is described with reference to FIG. 3. In FIG. 3, a photo sensor readout circuit 300 for one column of pixels includes a p-channel transistor 301 and a storage capacitor 302. Moreover, the photo sensor readout circuit 300 includes the photo sensor output signal line 211 and a precharge signal line 303 which are for the column of pixels.

In the photo sensor readout circuit 300, the potential of the photo sensor output signal line 211 is set at a reference potential before the operation of the photo sensor in the pixels. In FIG. 3, by setting the potential of the precharge signal line 303 at a potential “L (low),” the potential of the photo sensor output signal line 211 can be set to a high potential, which is a reference potential. Note that the storage capacitor 302 is not necessarily provided when parasitic capacitance of the photo sensor output signal line 211 is high. Note that a structure in which the reference potential is a low potential is acceptable. In that case, an n-channel transistor is used and the potential of the precharge signal line 303 is set at the potential “H,” whereby the potential of the photo sensor output signal line 211 can be set to a low potential, which is a reference potential.

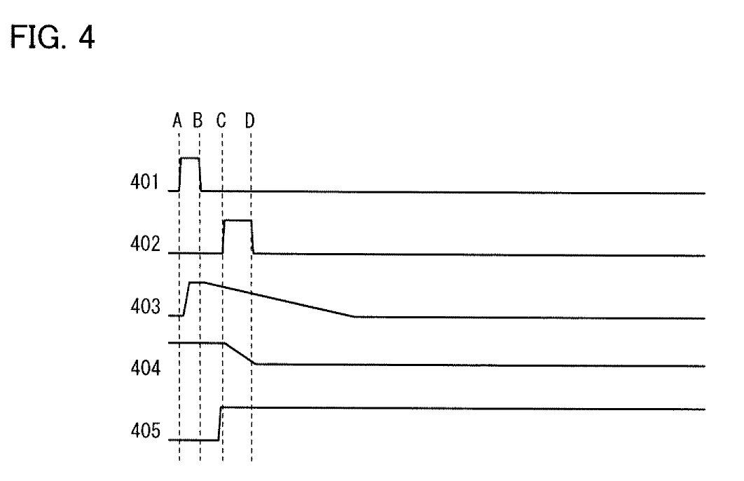

Next, a readout operation of the photo sensor of the display panel is described with reference to a timing chart in FIG. 4. In FIG. 4, signals 401 to 404 respectively correspond to the potential of the photodiode reset signal line 208, the potential of the gate signal line 209 to which the gate of the transistor 206 is connected, the potential of a gate signal line 213 to which the gate of the transistor 205 is connected, and the potential of the photo sensor output signal line 211 in FIG. 2. Moreover, a signal 405 corresponds to the potential of the precharge signal line 303 in FIG. 3.

At a time A, when the potential of the photodiode reset signal line 208 (the signal 401) is set at “H” (reset operation), the photodiode 204 is brought into electrical conduction and the potential of the gate signal line 213 to which the gate of the transistor 205 is connected (the signal 403) becomes “H.” Further, when the potential of the precharge signal line 303 (the signal 405) is set at “L,” the potential of the photo sensor output signal line 211 (the signal 404) is precharged to “H.”

At a time B, when the potential of the photodiode reset signal line 208 (the signal 401) is set at “L” (accumulating operation), the potential of the gate signal line 213 to which the gate of the transistor 205 is connected (the signal 403) begins to decrease due to off-state current of the photodiode 204. The off-state current increases when the photodiode 204 is illuminated; therefore, the potential of the gale signal line 213 to which the gate of the transistor 205 is connected (the signal 403) varies in accordance with the amount of the light with which the photodiode 204 is irradiated. That is, current between the source and the drain of the transistor 205 varies.

At a time C, when the potential of the gate signal line 209 (the signal 402) is set at “H” (selection operation), the transistor 206 is brought into electrical conduction and the photo sensor reference signal line 212 and the photo sensor output signal line 211 are in conduction through the transistor 205 and the transistor 206. Then, the potential of the photo sensor output signal line 211 (the signal 404) begins to decrease. Note that, in advance of the time C, the potential of the precharge signal line 303 (the signal 405) is set at “H” and precharge of the photo sensor output signal line 211 is completed. Here, a speed with which the potential of the photo sensor output signal line 211 (the signal 404) decreases depends on current between the source and the drain of the transistor 205. That is, the potential of the photo sensor output signal line 211 varies in accordance with the amount of light with which the photodiode 204 is irradiated.

At a time D, when the potential of the gate signal line 209 (the signal 402) is set at “L,” the transistor 206 is turned off and the potential of the photo sensor output signal line 211 (the signal 404) has a constant value from the time D. Here, the constant value depends on the amount of light with which the photodiode 204 is irradiated. Therefore, the amount of light with which the photodiode 204 is irradiated can be found by obtaining the value of the potential of the photo sensor output signal line 211.

From the amount of light with which the photodiode 204 is irradiated obtained in the above described manner, it can be determined whether ambient light is incident on the photodiode 204 or a contactless object prevents ambient light from being incident on the photodiode 204, that is, the portion where ambient light is blocked becomes a shadow.

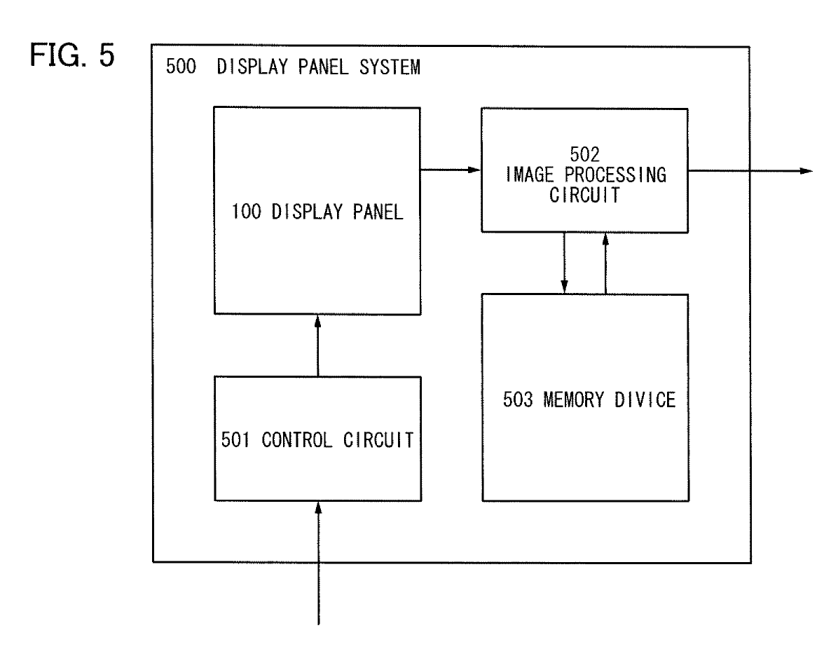

FIG. 5 shows a display panel system 500 which detects a motion of a contactless object using a shadow of the object. The display panel system 500 includes the display panel 100, a control circuit 501, an image processing circuit 502, and a memory device 503 which stores image data. The control circuit 501 generates various timing signals for driving the display panel. The image processing circuit 502 performs arithmetic processing on the imaging data of the shadow obtained by a photo sensor and detects a motion of the shadow. Furthermore, the image processing circuit 502 stores image data needed in the subsequent image processing in the memory device 503, and reads out the data stored in the memory device 503 and performs arithmetic processing thereon if needed.

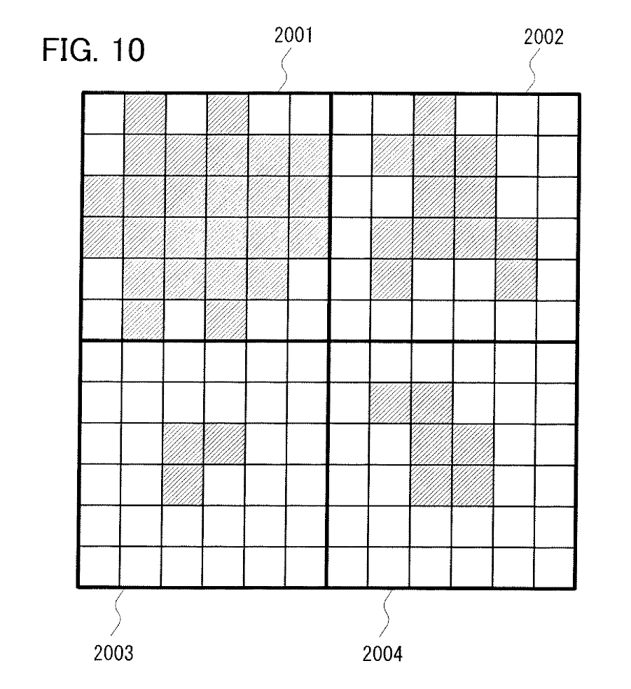

An example of a specific method of image processing performed by the image processing circuit 502 is described with reference to FIG. 10. In FIG. 10, a display area including 12×12 pixels is illustrated.

The image processing is performed as follows: 1) a position of an object is extracted from data obtained by capturing the shadow of the object (also referred to as imaging data); 2) a motion of the object is detected from positional data of the object which are continuously captured; 3) processing in response to the motion of the object is performed; and the like.

First, a method for extracting a position of the object from data obtained by capturing the shadow of the object (1) is described. As frames are marked with thick lines in FIG. 10, the display area is divided into four areas: an area 2001, an area 2002, an area 2003, and an area 2004, for example. In each area, a ratio of portions recognized as a shadow of the object to the area is calculated. More specifically, when the amount of light obtained by the photo sensor in each pixel is lower than a given threshold value, the pixel is recognized to be shaded by the object.

Then, an area in which a ratio of the pixels over which the shadow is cast to all of the pixels is the highest of the areas 2001 to 2004 is extracted as a position of the object. In FIG. 10, the pixels over which the shadow is cast are marked with diagonal lines. The ratio of the shaded pixels in each area is as follows: in the area 2001, the ratio is 25/36; the area 2002, 12/36; the area 2003, 3/36; and the area 2004, 6/36. The ratio of the pixels over which the shadow is cast is the highest in the area 2001; therefore, the area 2001 is identified as a position of the object and the positional data thereof is obtained.

Note that the display area is divided into more areas, whereby the position can be extracted more precisely.

Next, a method for detecting a motion of the object from positional data of the object which are continuously captured (2) is described. For example, the positional data is continuously obtained, and then an aimed positional data is compared with the positional data obtained before and after the aimed positional data, whereby the motion of the object can be found. Specifically, when the last positional data is the right and the positional data of this time is the left, the object can be detected to move from right to left. Moreover, in the case where the position is extracted more precisely, the more precise motion such as the motion speed in addition to the direction in which the object moves can be detected.

Subsequently, a method for performing processing in response to the motion of the object (3) is described. As an example of the processing, processing for controlling display in response to the motion of the object can be given. Specifically, processing in which a moving image is reproduced when the user moves the object from right to left, processing in which a moving image is stopped reproducing when the user moves the object from top to bottom, or the like can be given. Then, a signal (input data) is produced for performing the processing in response to the motion of the object, whereby the processing is performed.

As another example of the processing, processing in which a path of the motion of the object is recognized as letters or drawings can be given. That is, letters or drawings written/drawn by the object can be recognized as a signal (input data). In addition, in response to the motion of the object, pre-set letters or drawings may be read out.

It is effective that the sensitivity of the photo sensor is variable in accordance with the amount of light. In a structure shown in FIG. 2 or FIG. 3, for example, the potential applied to the photo sensor (the potential of the photodiode reset signal line 208, the potential of the gate signal line 209, the potential of the photo sensor reference signal line 212, or the potential of the precharge signal line 303) varies, so that the sensitivity is variable.

Thus, the sensitivity of the photo sensor is variable, which results in that the sensitivity can be set at an optimal value corresponding to the environment (the brightness or the like) where the display panel is used and a shadow of a contactless object can easily be recognized. Moreover, the display panel can be used not only for detecting a shadow of a contactless object but also as a contact area sensor.

With the above structure, a display panel capable of detecting a contactless object and inputting data can be provided.

Furthermore, the above image processing can be applied to the case of detecting light reflected from an object in addition to the case of detecting a shadow of the object. In the case of detecting reflection light, photo sensors placed at a position toward which an object moves receive stronger light than the other positions. That is, a region, in the display area, which receives stronger light is specified using the above image processing; therefore, the position, motion, or shape of the object can be detected. In this case, the pixels which are marked with diagonal lines in FIG. 10 receive stronger light reflected from the object.

Additionally, it is effective that a first photo sensor which detects a contactless object and a second photo sensor which detects a touch object are provided in the display panel. The second photo sensor is used as the contact area sensor. With such a structure, a display panel capable of detecting a contactless object, which is capable of detecting also a touch object, can be provided. That is, two types of detection functions can be used as appropriate depending on the usage of the display panel.

Pixels including the first photo sensor and pixels including the second photo sensor are arranged in matrix on the display panel. It is preferable that the number of second photo sensors is more than the number of first photo sensors. The second photo sensor serving as a contact area sensor is required to capture a high resolution image; therefore, a distance (a pitch) between the second photo sensors is short, whereby the resolution can be high. On the other hand, it is sufficient that the first photo sensor detecting a shadow can determine the position of the object; therefore, the first photo sensor is not required to have as high resolution as the second photo sensor used as a contact area sensor. That is, the distance between the arranged second photo sensors may be shorter than the distance between the arranged first photo sensors.

Note that pixels in which the first photo sensor detecting a shadow is provided are pixels in which the second photo sensor used as a contact area sensor is not provided. Therefore, the second photo sensors serving as a contact area sensor are preferably provided in about one to three pixels around the first photo sensor detecting a shadow so that an image in the pixels where the second photo sensor is not provided can be restored by image processing.

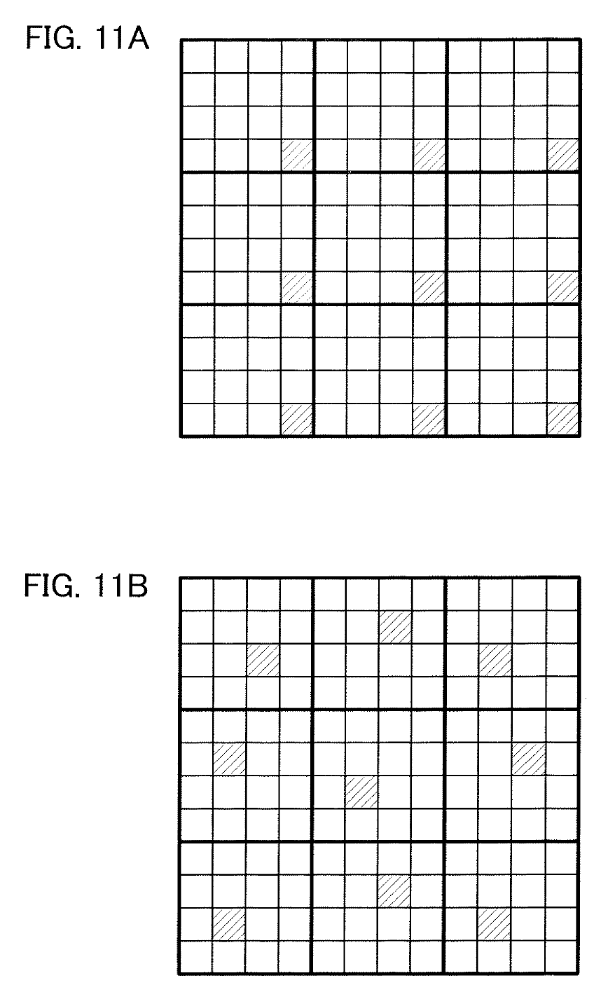

In FIG. 11A, an example of pixels where the first photo sensors detecting a shadow and the second photo sensors used as a contact area sensor are arranged is illustrated. In FIGS. 11A and 11B, although 12×12 pixels are used, the number of pixels is not limited to this.

In FIG. 11A, the first photo sensors are provided in pixels marked with diagonal lines, and the second photo sensors are provided in the other pixels. The first photo sensors and the second photo sensors are arranged at a distance from each other in matrix. Because of the above described reason, the number of second photo sensors is more than the number of first photo sensors.

Note that the first photo sensors and the second photo sensors are not necessarily arranged at a predetermined distance as illustrated in FIG. 11A, and may be arranged at random distances as illustrated in FIG. 11B. In the case where 640×480 pixels are used as a more practical example, when the pixels are divided into areas including hundred pixels of 10×10 pixels, a pixel of the hundred pixels is provided with the first photo sensor and the ninety-nine pixels are provided with the second photo sensors, which is effective enough for the device to detect a shadow of the object and to serve as a contact area sensor. However, the structure is not limited to this. The ratio of the arranged first photo sensors to the second photo sensors may be determined in accordance with the detection accuracy. The number of first photo sensors and the number of second photo sensors can be equal to each other, for example.

Note that, in the first photo sensor detecting a shadow and the second photo sensor used as a contact area sensor, it is effective that potential to be applied to each of the photo sensors (e.g., the potential of the photodiode reset signal line 208, the potential of the gate signal line 209, the potential of the photo sensor reference signal line 212, or the potential of the precharge signal line 303 in FIG. 2 or FIG. 3) is individually set. Moreover, it is effective that, as for each of the photo sensors, the size of a photodiode or the circuit structures of the photo sensors vary from one photo sensor to another.

In addition, although a device including a display panel is described in this embodiment, devices without a display panel may be acceptable. In that case, photo sensors are provided at a portion which is touched or approached by the object (also referred to as an input portion), and an image processing portion and the like may be provided as described above.

This embodiment can be implemented in combination with any of the other embodiments or the examples as appropriate.

### Embodiment 2

In this embodiment, a method for increasing detection accuracy of a photo sensor in the case where light reflected from an object is used is described.

For detection of a contactless object, slight light reflected from the object needs to be effectively detected. Specifically, the structure described below is acceptable.

A sensor which detects infrared light (an infrared light sensor) is provided in a display panel as a photo sensor. Then, the display panel emits infrared light, and the infrared light sensor detects light reflected from an object. The infrared light sensor can be provided with a stack of color filters of different colors (e.g., R (red) and B (blue), or R (red) and G (green)) on a photo detector, for example. With such a structure, light except for visible light (infrared light) can enter the photo detector. Note that the color filters are used also as filters for performing color display, whereby the number of processes can be reduced. Moreover, a light source emitting infrared light in addition to visible light (white) is added to a backlight, whereby the display panel can emit infrared light. As for infrared light, the wavelength is longer and the amount of scattering is smaller than visible light; therefore, the detection accuracy can be easily increased. The structure of detecting infrared light is effective, in particular in the case where the objects are human fingers or hands.

When an infrared light sensor and a visible light sensor are each formed using different materials, the infrared light sensor may be formed using a material which absorbs light except for visible light (infrared light). For example, a photo sensor formed using InGaAs, PbS, PbSe, or the like absorbs infrared light effectively.

In the structure described in Embodiment 1 where the first photo sensor detecting a contactless object and the second photo sensor detecting a touch object are provided in the display panel, an infrared light sensor is used for the first photo sensor and a visible light sensor is used for the second photo sensor. Therefore, the accuracy of a function of detecting a contactless object and a function as a contact area sensor can be both improved. The first photo sensors (the infrared light sensors) and the second photo sensors (the visible light sensors) can be arranged in a manner similar to that of Embodiment 1.

Moreover, the image processing described in Embodiment 1 can be adopted.

This embodiment can be implemented in combination with any of the other embodiments or the examples as appropriate.

### Embodiment 3

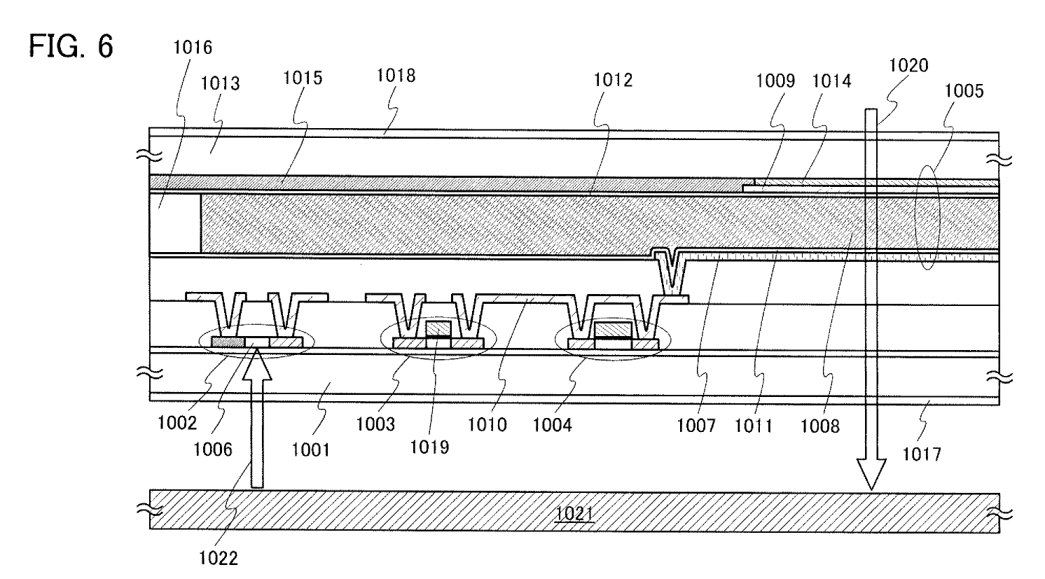

FIG. 6 illustrates an example of a cross-sectional view of the display panel. In the display panel illustrated in FIG. 6, a photodiode 1002, a transistor 1003, a storage capacitor 1004, and a liquid crystal element 1005 are provided over a substrate (a TFT substrate) 1001 having an insulating surface.

The photodiode 1002 and the storage capacitor 1004 can be formed in a manufacturing process of the transistor 1003 at the same time as when the transistor 1003 is formed. The photodiode 1002 is a lateral junction pin diode. A semiconductor film 1006 included in the photodiode 1002 has a region having p-type conductivity (a p layer), a region having i-type conductivity (an i layer), and a region having n-type conductivity (an n layer). Note that although the ease where the photodiode 1002 is a pin diode is described in this embodiment, the photodiode 1002 may be a pn diode. An impurity imparting p-type conductivity and an impurity imparting n-type conductivity can be added to respective particular regions in the semiconductor film 1006, whereby a lateral pin junction or a lateral pn junction are formed.

Further, one semiconductor film formed over the TFT substrate 1001 is processed into desired patterns by etching or the like (patterned); thus, an island-shaped semiconductor film for the photodiode 1002, an island-shaped semiconductor film for the transistor 1003, and an island-shaped semiconductor film (a lower electrode) for the storage capacitor 1004 are formed in the same process. Therefore, the number of manufacturing processes and the cost can be reduced.

Note that a structure where a p layer, an i layer, and an n layer are stacked is acceptable instead of the lateral junction photodiode.

The liquid crystal element 1005 includes a pixel electrode 1007, liquid crystals 1008, and a counter electrode 1009. The pixel electrode 1007 is formed over the TFT substrate 1001 and is electrically connected to the transistor 1003 through the storage capacitor 1004 and a conductive film 1010. Further, a substrate (a counter substrate) 1013 is provided with the counter electrode 1009, and the liquid crystals 1008 are sandwiched between the pixel electrode 1007 and the counter electrode 1009. Note that although a transistor used for a photo sensor is not illustrated in FIG. 6, the transistor can also be formed over the TFT substrate 1001 in the manufacturing process of the transistor 1003 at the same time as when the transistor 1003 is formed.

A cell gap between the pixel electrode 1007 and the counter electrode 1009 can be controlled using a spacer 1016. Although the cell gap is controlled using the spacer 1016 which is selectively formed by photolithography and has a columnar shape in FIG. 6, the cell gap can alternatively be controlled by sphere spacers dispersed between the pixel electrode 1007 and the counter electrode 1009.

Further, the liquid crystals 1008, between the TFT substrate 1001 and the counter substrate 1013, are surrounded by a sealing material. The liquid crystals 1008 may be injected by a dispenser method (a droplet method) or a dipping method (a pumping method).

As the pixel electrode 1007, a light-transmitting conductive material can be used; for example, indium tin oxide (ITO), indium tin oxide containing silicon oxide (ITSO), organoindium, organotin, zinc oxide, indium zinc oxide (IZO) containing zinc oxide, zinc oxide containing gallium, tin oxide, indium oxide containing tungsten oxide, indium zinc oxide containing tungsten oxide, indium oxide containing titanium oxide, indium tin oxide containing titanium oxide, or the like can be used.

In addition, since the transmissive liquid crystal element 1005 is given as an example in this embodiment, the above-described light-transmitting conductive material can be used for the counter electrode 1009 together with the pixel electrode 1007.

An alignment film 1011 is provided between the pixel electrode 1007 and the liquid crystals 1008, and an alignment film 1012 is provided between the counter electrode 1009 and the liquid crystals 1008. The alignment film 1011 and the alignment film 1012 can be formed using an organic resin such as polyimide or polyvinyl alcohol. An alignment treatment such as rubbing is performed on the surface of the alignment film 1011 and the surface of the alignment film 1012 in order to align the liquid crystal molecules in a particular direction. Rubbing can be performed in such a manner that a roller wrapped with cloth of nylon or the like is rolled while applying pressure on the alignment film so that the surface of the alignment film is rubbed in a particular direction. Note that by using an inorganic material such as silicon oxide, the alignment film 1011 and the alignment film 1012 each having an alignment property can be directly formed by an evaporation method without performing an alignment treatment.

Further, the counter substrate 1013 is provided with a color filter 1014 capable of transmitting light in a particular wavelength range so as to overlap the liquid crystal element 1005. The color filter 1014 can be selectively formed by photolithography after an organic resin such as an acrylic-based resin in which colorant is dispersed is applied on the substrate 1013. Alternatively, the color filter 1014 can be selectively formed by etching after a polyimide-based resin in which colorant is dispersed is applied on the substrate 1013. Alternatively, the color filter 1014 can be selectively formed by a droplet discharge method such as an ink jet method.

Further, the counter substrate 1013 is provided with a shielding film 1015 capable of blocking light so as to cover over the photodiode 1002. The shielding film 1015 can prevent light passing through the counter substrate 1013 and entering the display panel from reaching the photodiode 1002 directly. In addition, the shielding film 1015 can prevent disclination due to disorder of alignment of the liquid crystals 1008 among pixels from being observed. An organic resin containing black colorant such as carbon black or titanium lower oxide can be used for the shielding film 1015. Alternatively, a film of chromium can be used for the shielding film 1015.

Moreover, a polarizing plate 1017 is provided on the opposite side of the TFT substrate 1001 from the side on which the pixel electrode 1007 is formed, and a polarizing plate 1018 is provided on the opposite side of the counter substrate 1013 from the side on which the counter electrode 1009 is formed.

The liquid crystal element may include VA (vertical alignment) mode, OCB (optically compensated birefringence) mode. IPS (in-plane switching) mode, or the like in addition to TN (twisted nematic) mode. Note that although the liquid crystal element 1005 in which the liquid crystals 1008 are sandwiched between the pixel electrode 1007 and the counter electrode 1009 is described as an example in this embodiment, the display panel in one embodiment of the present invention is not limited to this structure. A liquid crystal element in which a pair of electrodes are formed on the TFT substrate 1001 side like an IPS liquid crystal element may also be acceptable.

In addition, although the case where the photodiode 1002, the transistor 1003, and the storage capacitor 1004 are formed using a thin semiconductor film is described as an example in this embodiment, a single crystal semiconductor substrate, an SOT substrate, or the like may also be used for the photodiode 1002, the transistor 1003, and the storage capacitor 1004.

The display panel is irradiated with light from the backlight which is on the counter substrate 1013 side. That is, the light from the backlight passes through the liquid crystal element 1005 and reaches an object 1021 on the TFT substrate 1001 side as shown by an arrow 1020. Then, light reflected from the object 1021 is incident on the photodiode 1002 as shown by an arrow 1022.

When ambient light is detected, the display panel is irradiated with ambient light from the TFT substrate 1001 side. The ambient light is blocked by the object 1021, and light to be incident on the photodiode 1002 is blocked. That is, the photodiode 1002 is to detect a shadow of the object.

The display panel of such a structure as described above can input data by detecting a motion of the object.

In addition, the display device of this embodiment can also detect an object even when the object is close to the display panel. The distance can be set at three centimeters or shorter. The display device in this embodiment is more effective than the device provided with a CCD image sensor or the like.

Additionally, in the display device of this embodiment, a light receiving surface of the photo sensor (the photodiode 1002) and a display surface of the display panel (on the side of the TFT substrate 1001) face in the same direction. Therefore, the object can be captured by the display panel, and the display device of this embodiment is more effective than the device provided with a CCD image sensor or the like.

This embodiment can be implemented in combination with any of the other embodiments or the examples as appropriate.

### Embodiment 4

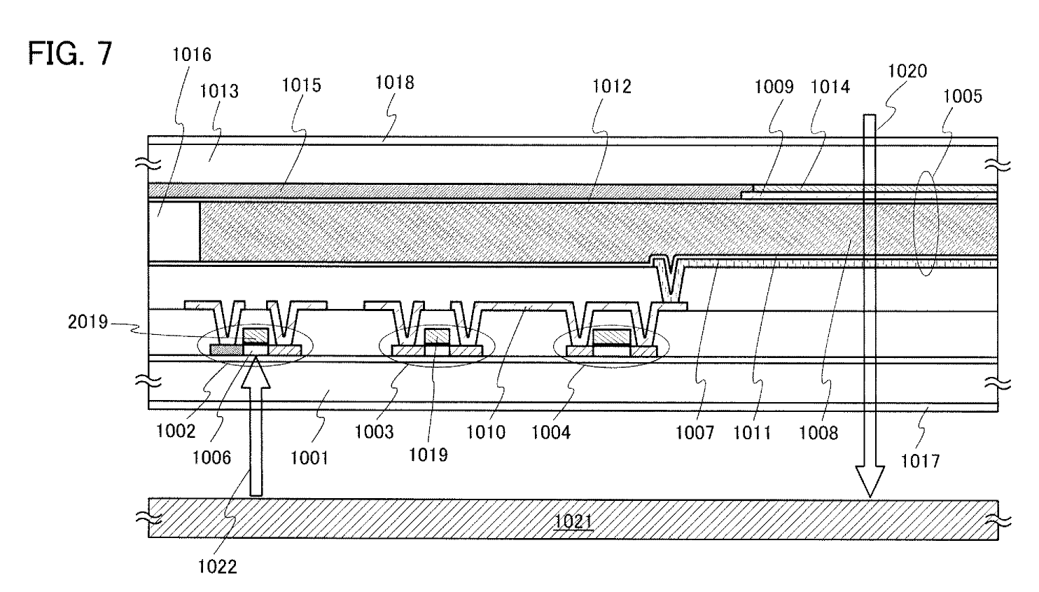

FIG. 7 illustrates an example of a cross-sectional view of a display panel different from the display panel of Embodiment 3. In FIG. 7, the photodiode 1002 is provided with a shielding film 2019. The shielding film 2019 is formed using the same material as a conductive film 1019 serving as a gate electrode of the transistor 1003 at the same time as when the conductive film 1019 is formed. The shielding film included in the photodiode 1002 can prevent light from the backlight from entering the light receiving portion directly. Accordingly, only light reflected from the object can be effectively detected.

Further, the shielding film 2019 is used as a mask when a region having p-type conductivity (a p layer) and a region having n-type conductivity (an n layer) are formed, whereby the impurities can be added in a self-alignment manner. This is effective in manufacturing a minute photodiode, in reducing the pixel size, and in improving the aperture ratio.

The display panel of such a structure also can input data by detecting a motion of the object in a manner similar to that of Embodiment 3.

Note that although a lateral junction photodiode is used in FIG. 7, a structure where a p layer, an i layer, and an n layer are stacked is acceptable.

Note that the following are similar to Embodiment 3: the other structures of the display panel; light incident on the photodiode 1002; the distance between the object and the display panel; and the directions of the light receiving surface of the photo sensor and the display surface of the display panel.

This embodiment can be implemented in combination with any of the other embodiments or the examples as appropriate.

### Embodiment 5

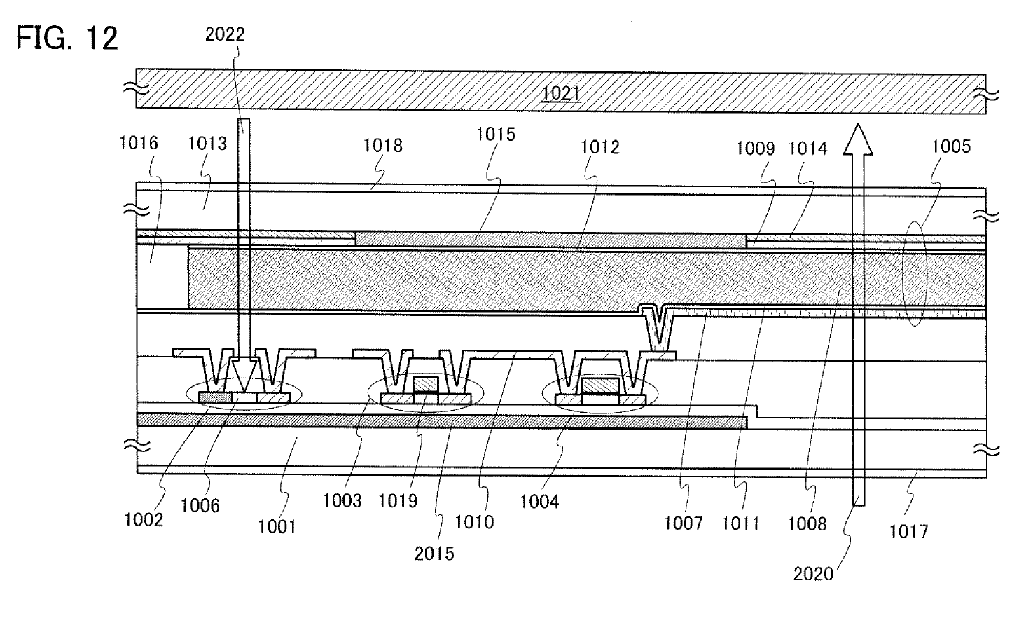

FIG. 12 illustrates an example of a cross-sectional view of a display panel different from the display panel of Embodiment 3 and the display panel of Embodiment 4. The display panel illustrated in FIG. 12 is different from the display panels illustrated in FIG. 6 and FIG. 7 in that the display panel is irradiated with light from the backlight which is on the TFT substrate 1001 side. That is, the light from the backlight passes through the liquid crystal element 1005 and reaches the object 1021 on the counter substrate 1013 side as shown by an arrow 2020. Then, light reflected from the object 1021 as shown by an arrow 2022 enters the photodiode 1002. In this case, an opening may be formed in the shielding film 1015 above the photodiode 1002 for example, so that light reflected from the object 1021 can be incident on the photodiode 1002.

In this embodiment, a shielding film 2015 is provided under the photodiode 1002. The shielding film 2015 can prevent the light, from the backlight, which passes through the TFT substrate 1001 and enters the display panel from reaching the photodiode 1002 directly; thus, a display panel capable of capturing a high resolution image can be provided. An organic resin containing black colorant such as carbon black or titanium lower oxide can be used for the shielding film 2015. Alternatively, a film of chromium can be used for the shielding film 2015.

When infrared light is detected using the photodiode 1002, the color filter 1014 which transmits infrared light may be provided over the photodiode 1002. In this case, the color filter is formed in such a manner that color filters of different colors are preferably stacked over the photodiode 1002.

Note that although a lateral junction photodiode is used in FIG. 12, a structure where a p layer, an i layer, and an n layer are stacked is acceptable.

Moreover, when ambient light is detected, the display panel is irradiated with ambient light from the counter substrate 1013 side. The ambient light is blocked by the object 1021, and light to be incident on the photodiode 1002 is blocked. That is, the photodiode 1002 is to detect a shadow of the object.

The following are similar to Embodiment 3: the distance between the object and the display panel; and the directions of the light receiving surface of the photo sensor and the display surface of the display panel. The light receiving surface of the photo sensor faces in the same direction as the display surface of the display panel (toward the counter substrate 1013); thus, the display panel can capture the object.

This embodiment can be implemented in combination with any of the other embodiments or the examples as appropriate.

### Example 1

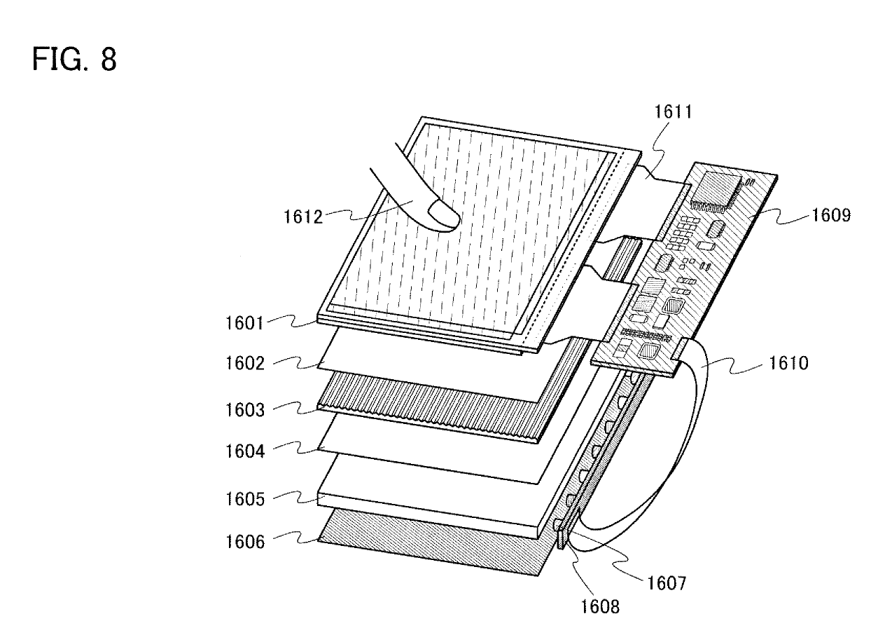

In this example of the present invention, the arrangement of a panel and light sources in a display panel is described. FIG. 8 illustrates an example of a perspective view showing the structure of a display panel according to one embodiment of the present invention. A display panel illustrated in FIG. 8 includes a panel 1601 in which a pixel including a liquid crystal element, a photodiode, a thin film transistor, and the like is formed between a pair of substrates; a first diffuser plate 1602; a prism sheet 1603; a second diffuser plate 1604; a light guide plate 1605; a reflector plate 1606; a backlight 1608 including a plurality of light sources 1607; and a circuit board 1609.

The panel 1601, the first diffuser plate 1602, the prism sheet 1603, the second diffuser plate 1604, the light guide plate 1605, and the reflector plate 1606 are stacked in that order. The light sources 1607 are provided at an end portion of the light guide plate 1605. Light from the light sources 1607 which is diffused in the light guide plate 1605 is uniformly emitted to the panel 1601 from the counter substrate side by the first diffuser plate 1602, the prism sheet 1603, and the second diffuser plate 1604.

Note that although the first diffuser plate 1602 and the second diffuser plate 1604 are used in this example, the number of diffuser plates is not limited thereto. The number of diffuser plates may be one, or may be three or more. The diffuser plate(s) is acceptable as long as it is provided between the light guide plate 1605 and the panel 1601. Therefore, the diffuser plate may be provided only on the side closer to the panel 1601 than the prism sheet 1603, or may be provided only on the side closer to the light guide plate 1605 than the prism sheet 1603.

Moreover, the shape of the cross section of the prism sheet 1603 is not limited to a sawtooth shape as illustrated in FIG. 8, and may be a shape capable of collecting light from the light guide plate 1605 over the panel 1601.

The circuit board 1609 is provided with a circuit for generating or processing various signals to be input to the panel 1601, a circuit for processing various signals to be output from the panel 1601, and the like. In addition, the circuit board 1609 and the panel 1601 are connected to each other via a flexible printed circuit (FPC) 1611 in FIG. 8. Note that the above circuits may be connected to the panel 1601 by a chip on glass (COG) method, or part of the above circuits may be connected to the FPC 1611 by a chip on film (COF) method.

FIG. 8 illustrates an example in which a control circuit for controlling the driving of the light sources 1607 is provided in the circuit board 1609, and the control circuit and the light sources 1607 are connected to each other via a FPC 1610. Note that the above control circuit may be formed in the panel 1601; in this case, the panel 1601 and the light sources 1607 are to be connected to each other via an FPC or the like.

Note that although FIG. 8 illustrates an edge-light type light source in which the light sources 1607 are provided at an end portion of the light guide plate 1605, a display panel according to one embodiment of the present invention may be a direct type light source in which the light sources 1607 are provided directly below the panel 1601.

For example, when a finger 1612 as an object gets close to the panel 1601 from the TFT substrate side, part of light from the backlight 1608 that passes through the panel 1601 is reflected from the finger 1612 and incident on the panel 1601 again. The light sources 1607 turn on sequentially in such a manner that the light sources of the same color turn on at the same time, and then the object is captured using the light sources of every color so as to obtain the imaging data of every color. Therefore, colored imaging data of the finger 1612 as the object can be obtained.

This example can be implemented in combination with any of the embodiments or the other examples as appropriate.

### Example 2

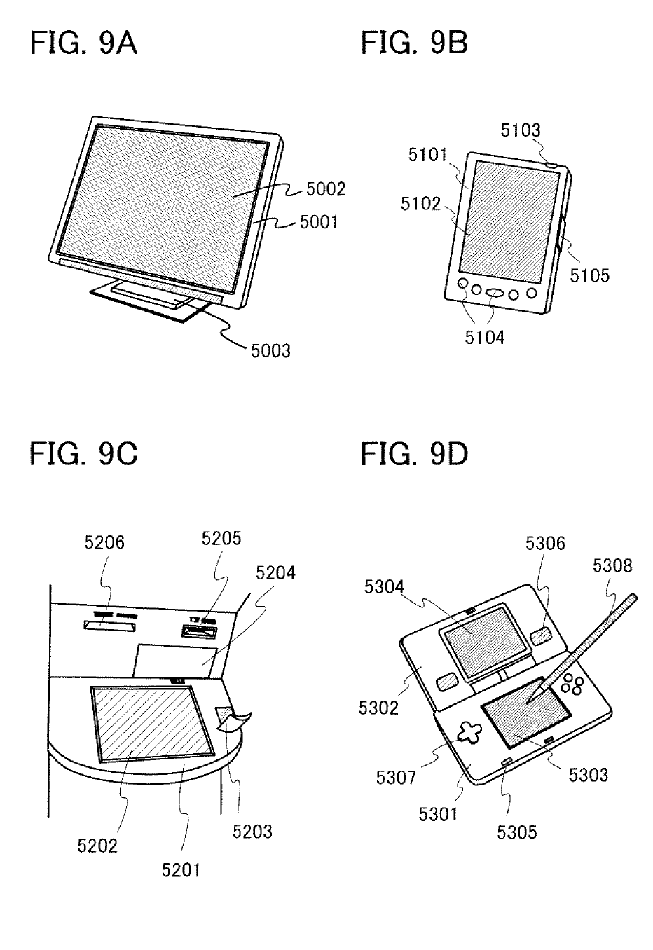

A display panel according to one embodiment of the present invention is characterized in that the display panel can input data by detecting a motion of a contactless object. Therefore, an electronic device using the display panel according to one embodiment of the present invention can be equipped with a higher-performance application due to the display panel added as a component. The display panel according to one embodiment of the present invention can be included in display devices, laptop personal computers, and image reproducing devices provided with recording media (typically devices which reproduce the content of recording media such as DVDs (digital versatile discs) and include displays for displaying the reproduced images). In addition to the above examples, as an electronic device which can include the display panel according to one embodiment of the present invention, mobile phones, portable game consoles, portable information terminals, e-book readers, video cameras, digital still cameras, goggle-type displays (head mounted displays), navigation systems, audio reproducing devices (e.g., car audio components and digital audio players), copiers, facsimiles, printers, multifunction printers, automated teller machines (ATM), vending machines, and the like can be given. Specific examples of these electronic devices are shown in FIGS. 9A to 9D.

FIG. 9A illustrates a display device which includes a housing 5001, a display portion 5002, a support 5003, and the like. The display panel according to one embodiment of the present invention can be used for the display portion 5002. The display panel according to one embodiment of the present invention used for the display portion 5002 can make it possible to provide a display device capable of obtaining imaging data with high resolution and being equipped with higher-performance applications. Note that the display device includes all display devices for displaying information, such as display devices for personal computers, display devices for receiving TV broadcast, and display devices for advertisements, in its category.

FIG. 9B illustrates a portable information terminal which includes a housing 5101, a display portion 5102, a switch 5103, operation keys 5104, an infrared port 5105, and the like. The display panel according to one embodiment of the present invention can be used for the display portion 5102. The display panel according to one embodiment of the present invention used for the display portion 5102 can make it possible to provide a portable information terminal capable of obtaining imaging data with high resolution and being equipped with higher-performance applications.

FIG. 9C illustrates an automated teller machine which includes a housing 5201, a display portion 5202, a coin slot 5203, a bill slot 5204, a card slot 5205, a passbook slot 5206, and the like. A display panel according to one embodiment of the present invention can be used for the display portion 5202. The display panel according to one embodiment of the present invention used for the display portion 5202 can make it possible to provide an automated teller machine capable of obtaining imaging data with high resolution and being equipped with higher-performance applications. An automated teller machine using a display panel according to one embodiment of the present invention can read, with higher precision, biological information to be used for biometric authentication, such as a fingerprint, a face, a hand print, a palm print, a hand vein pattern, or an iris. Therefore, a false non-match rate which is the rate at which a person to be identified is recognized as a different person and a false acceptance rate which is the rate at which a different person is recognized as a person to be identified in biometric authentication can be suppressed.

FIG. 9D illustrates a portable game console which includes a housing 5301, a housing 5302, a display portion 5303, a display portion 5304, a microphone 5305, a speaker 5306, an operation key 5307, a stylus 5308, and the like. The display panel according to one embodiment of the present invention can be used for the display portion 5303 or the display portion 5304. The display panel according to one embodiment of the present invention used for the display portion 5303 or the display portion 5304 can make it possible to provide a portable game console capable of obtaining imaging data with high resolution and being equipped with higher-performance applications. Note that although the portable game console illustrated in FIG. 9D includes two display portions, namely the display portion 5303 and the display portion 5304, the number of display portions included in the portable game console is not limited thereto.

Note that one embodiment of the present invention can also be applied to devices which are not necessarily provided with a display panel, such as a fingerprint authentication device. Such a device includes an input portion provided with photo sensors. The photo sensors can detect an object touching or approaching the input portion.

This example can be implemented in combination with any of the embodiments or the other examples as appropriate.

### Example 3

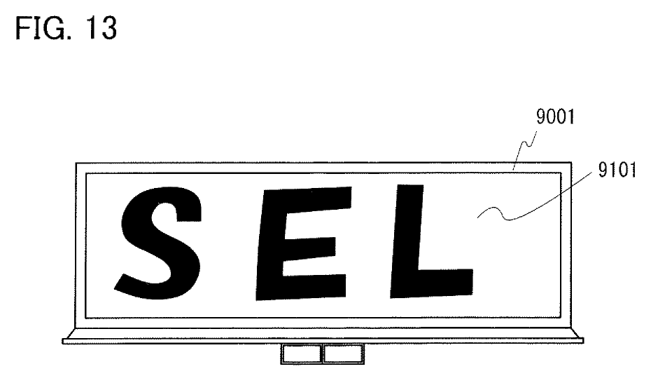

In this example, an example of electronic devices is described with reference to FIG. 13.

FIG. 13 illustrates a writing board (e.g., a black board or a white board). An input portion such as a display panel according to one embodiment of the present invention can be provided in a writing surface 9101 of a main body 9001.

Here, the surface of the writing surface 9101 can be freely written on with a marker pen or the like.

Note that when the marker pen does not include fixative, the written letters can be easily erased.

Moreover, the surface of the writing surface 9101 may be sufficiently smooth so that ink of a marker pen is easily erased.

For example, when the surface of the writing surface 9101 is a glass substrate or the like, the smoothness is sufficient.

Further, a transparent synthetic resin sheet or the like may be attached to the surface of the writing surface 9101.

As a synthetic resin, acrylic or the like is preferably used, for example. In this case, the surface of the synthetic resin sheet is preferably made to be smooth.

Moreover, even while the writing surface 9101 displays images, pictures or letters can be drawn/written on the surface. Additionally, the pictures or the letters can be superimposed on the displayed image of the writing surface 9101.

In addition, the drawn/written pictures or letters can be detected even when time has elapsed after the drawing/writing since the writing surface 9101 is provided with photo sensors; while the pictures or letters can be detected only at the same time as when the pictures or letters are drawn/written in the case where a writing surface is provided with a resistive touch sensor, a capacitance touch sensor, and the like instead.

This example can be implemented in combination with any of the embodiments or the other examples as appropriate.

This application is based on Japanese Patent Application serial no. 2009-245530 filed with Japan Patent Office on Oct. 26, 2009, the entire contents of which are hereby incorporated by reference.

1. A semiconductor device comprising:
an input portion including a plurality of pixels, the plurality of pixels arranged in matrix; and
an image processing portion operationally connected to the input portion,
wherein at least one of the plurality of pixels includes a photo sensor,
wherein the photo sensor is configured to detect a shadow of an object over the input portion,
wherein the image processing portion is capable of detecting a position of the object by using data of the shadow of the object, which is obtained by the photo sensor, and
wherein the photo sensor is capable of detecting the shadow of the object which is not in contact with the input portion.

2. The semiconductor device according to claim 1,
wherein the image processing portion is capable of detecting a motion of the object by using the data of the shadow of the object which is obtained by the photo sensor.

3. The semiconductor device according to claim 1,
wherein each of the plurality of pixels comprises a liquid crystal element.

4. The semiconductor device according to claim 1,
wherein each of the plurality of pixels comprises a light emitting element.

5. A display device comprising:
a display panel including a plurality of pixels, the plurality of pixels arranged in matrix; and
an image processing portion operationally connected to the display panel,
wherein at least one of the plurality of pixels includes a photo sensor,
wherein the photo sensor is configured to detect a shadow of an object over the display panel,
wherein the image processing portion is capable of detecting a position of the object by using data of the shadow of the object, which is obtained by the photo sensor, and
wherein the photo sensor is capable of detecting the shadow of the object which is not in contact with the display panel.

6. The display device according to claim 5,
wherein the image processing portion is capable of detecting a motion of the object by using the data of the shadow of the object which is obtained by the photo sensor.

7. A display device comprising:
a display panel including a plurality of areas, the plurality of areas each including a plurality of pixels arranged in matrix; and
an image processing portion operationally connected to the display panel,
wherein at least one of the plurality of pixels in each of the plurality of areas includes a photo sensor,
wherein the photo sensor is configured to detect a shadow of an object over the display panel,
wherein the image processing portion is capable of identifying one of the plurality of areas where a larger amount of the shadow is detected than the other of the plurality of areas as a position of the object, and
wherein the photo sensor is capable of detecting the shadow of the object which is not in contact with the display panel.

8. The display device according to claim 7,
wherein the image processing portion is capable of detecting a motion of the object by using continuous data of the position of the object.

9. A display device comprising:
a display panel including:
a photodetector portion including a plurality of first pixels, the plurality of first pixels each including a first photo sensor; and
an area sensor portion including a plurality of second pixels, the plurality of second pixels each including a second photo sensor; and
an image processing portion operationally connected to the display panel,
wherein the first photo sensor is configured to detect a shadow of an object over the display panel,
wherein the image processing portion is capable of detecting a position of the object using data of the shadow of the object, which is obtained by the first photo sensor, and
wherein the first photo sensor is capable of detecting the shadow of the object which is not in contact with the display panel.

10. The display device according to claim 9,
wherein the image processing portion is capable of detecting a motion of the object by using the data of the shadow of the object which is obtained by the first photo sensor.

11. The display device according to claim 9,
wherein the number of the plurality of second pixels is more than the number of the plurality of first pixels.

12. The display device according to claim 9,
wherein the plurality of first pixels are arranged around the plurality of second pixels.

13. The display device according to claim 9,
wherein the first photo sensor is an infrared light sensor.

14. The display device according to claim 9,
wherein the second photo sensor is a visible light sensor.

15. A display device comprising:
a display panel including a plurality of areas, the plurality of areas each including:
a photodetector portion including a plurality of first pixels, the plurality of first pixels each including a first photo sensor; and
an area sensor portion including a plurality of second pixels, the plurality of second pixels each including a second photo sensor; and
an image processing portion operationally connected to the display panel,
wherein the first photo sensor is configured to detect a shadow of an object over the display panel,
wherein the image processing portion is capable of identifying one of the plurality of areas where a larger amount of the shadow is detected than the other of the plurality of areas as a position of the object, and
wherein the first photo sensor is capable of detecting the shadow of the object which is not in contact with the display panel.

16. The display device according to claim 15,
wherein the image processing portion is capable of detecting a motion of the object by using continuous data of the position of the object which is obtained by the first photo sensor.

17. The display device according to claim 15,
wherein the number of the plurality of second pixels is more than the number of the plurality of first pixels.

18. The display device according to claim 15,
wherein the plurality of first pixels are arranged around the plurality of second pixels.

19. The display device according to claim 15,
wherein the first photo sensor is an infrared light sensor.

20. The display device according to claim 15,
wherein the second photo sensor is a visible light sensor.
